(19) United States
(12) Patent Application Publication
(10) Pub. No.: US 2021/0182877 A1
(43) Pub. Date: Jun. 17, 2021

(54) METHOD AND SYSTEM TO DETERMINE BUSINESS SEGMENTS ASSOCIATED WITH MERCHANTS

(71) Applicant: Intuit Inc., Mountain View, CA (US)

(72) Inventors: Yair Horesh, Kfar-Saba (IL); Onn Bar, Raanana (IL); Oren Sar Shalom, Nes Ziona (IL); Daniel Ben David, Mesilat Zion (IL); Alexander Zicharevich, Petah Tikva (IL); Talia Tron, Shefayim (IL)

(73) Assignee: Intuit Inc., Mountain View, CA (US)

(21) Appl. No.: 16/710,973

(22) Filed: Dec. 11, 2019

(51) Int. Cl. G06Q 30/02; G06N 20/00; G06Q 40/02

(52) U.S. Cl. CPC G06Q 30/0201; G06Q 40/02; G06N 20/00

(57) ABSTRACT

The business segment associated with a merchant is automatically and accurately determined by applying machine learning techniques to actual financial documents associated with a merchant. In some examples, once the business segment associated with a merchant user of a data management system is identified, this information is used to identify potentially fraudulent and/or other criminal activity such as fraudulent merchants, criminal financial transactions, and fraudulent invoices.

### BACKGROUND

Data management systems, such as transaction data management systems, personal financial management systems, small business accounting and management systems, tax preparation systems, and the like, have proven to be valuable and popular tools for helping users of these systems perform various tasks and manage their personal and professional lives.

When the user of a data management system is a merchant, such as a small business owner, it is often necessary to accurately identify the type of commercial activity or “business segment” that is associated with the merchant. Determining the business segment associated with a merchant is often legally mandated in order to meet various reporting and compliance requirements such as capital evaluation, tax reporting, and to prevent illegal operations such money laundering. In addition, determining the business segment associated with a merchant can also be used by the provider of the data management system to provide the user with more relevant information and features.

Despite the need to accurately determine the business segment associated with merchant users of data management systems, obtaining this information has historically proven to be difficult. The historic difficulty in accurately determining the business segment associated with merchants has its roots in the fact that, historically, the merchant users themselves have been asked to provide the information regarding the business segment in which they operate. This has proven extremely ineffective with more than 60% of merchants failing to provide accurate data indicating their business segment. In many cases the merchants simply fail to provide any information regarding their business segment. In other cases, the merchants provide incorrect information, either unintentionally or, in some cases, intentionally.

One of the reasons so many merchants fail to provide accurate data indicating their business segment is that many merchants do not understand coding systems and specific codes used to identify business segments. Typically, a merchant's business segment is identified using one or more standardized business segment categories and codes provided through one or more standardized business segment classification systems. Specific examples of standardized business segment classification systems include, but are not limited to, the North American Industry Classification System (NAICS) and the Merchant Category Code system (MCC). However, the categories, classifications, and codes provided through standardized business segment classification systems are often complicated, hierarchically related, and can be quite granular. This makes it difficult for merchants to understand and use these systems and codes. In addition, the codes used by one system, such as NAICS, are entirely different from the codes used by another system, such as MCC. This again makes it difficult for a given merchant to determine what code, or codes, apply to their business activities.

In addition, merchants often fail to provide accurate data indicating their business segment because they anticipate changes in their business segment and are hesitant to “lock” themselves into a given segment. For instance, an automobile service provider may envision moving into the auto parts or auto sales business and therefore may be hesitant to identify their business using an automobile service-related code. Similarly, a retail supplier of goods may envision moving into the wholesale market and therefore may identify the business as wholesale when, in fact, presently, the business is retail.

In addition, as discussed in more detail below, in some cases such as those involving fraudulent or criminal activity, users may intentionally fail to provide data indicating their business segment or intentionally provide incorrect/inaccurate data indicating their business segment

For these, and numerous other reasons, the fact remains that the majority of merchant users of small business data management systems either fail to provide data indicating their business segment or provide incorrect/inaccurate data indicating their business segment. Given the various legally mandated reporting requirements, the desire to provide relevant user experiences, and the desire to identify and prevent fraudulent/illegal activity, this is a significant and long-standing problem for providers of data management systems.

What is needed is a technical solution to the technical problem of accurately determining the business segment associated with a merchant user of a data management system.

### SUMMARY

The systems and methods of the present disclosure provide a technical solution to the technical problem of automatically, accurately, effectively, and efficiently determining the business segment associated with a merchant user of a data management system. In addition, the systems and methods of the present disclosure can be used to identify fraudulent or other criminal activity such as fraudulent merchants, criminal monetary transactions, and fake invoices.

The systems and methods of the present disclosure provide this technical solution by obtaining categorized merchant financial documents data representing one or more financial documents associated with one or more categorized merchants. Herein, a categorized merchant is a merchant having been identified as conducting business in a respective business segment.

The obtained categorized merchant financial documents data is then processed to generate categorized merchant financial document training data by correlating features of the categorized merchant financial documents data for each of the categorized merchants with the respective business segment associated with each of the categorized merchants.

The categorized merchant financial document training data is then used to train a machine learning-based merchant business segment prediction model to determine business segment probability scores based on merchant financial document data.

Once the machine learning-based merchant business segment prediction model is trained, uncategorized merchant financial document data representing financial documents associated with an uncategorized merchant is obtained. Herein, an uncategorized merchant is a merchant not having been identified as conducting business in a respective business segment.

The uncategorized merchant financial document data is then provided to the trained machine learning-based merchant business segment prediction model and a probable business segment for the uncategorized merchant is determined using the machine learning-based merchant business segment prediction model.

The determined probable business segment for the uncategorized merchant is then assigned to the previously uncategorized merchant. In one embodiment, probability data indicating the probability the business segment assigned to the merchant is the correct business segment is also provided. Then based in part on the determined probable business segment for the merchant various legal reporting requirements associated with the determined probable business segment for the merchant are met, more relevant user experiences associated with the determined probable business segment for the merchant can be provided; and fraudulent/illegal activity can be more readily identified.

Therefore, the systems and methods of the present disclosure use machine learning techniques to automatically and accurately determine the business segment associated with a merchant user of a data management system. Unlike traditional systems which rely on self-reported business segment identification, using the systems and methods of the present disclosure, the business segment is identified using machine learning-based analysis of the actual financial documents generated by, and associated with, the merchant. Consequently, the systems and methods of the present disclosure provide a technical solution to the technical problem of automatically, accurately, effectively, and efficiently determining the business segment associated with a merchant user of a data management system.

In addition, in one embodiment, once the one or more merchant business segment prediction models are trained, the systems and methods of the present disclosure are used to identify fraudulent or criminal activity such as fraudulent merchants, criminal monetary transactions, and fake invoices.

This is accomplished by obtaining subject merchant financial document data representing financial documents associated with a subject merchant, the subject merchant having been previously identified as conducting business in a respective business segment. The subject merchant financial document data is then provided to the trained machine learning-based merchant business segment prediction model. Using the machine learning-based merchant business segment prediction model, a probable business segment for the subject merchant is determined. The determined probable business segment for the subject merchant is then compared to the previously identified business segment for the subject merchant. If the determined probable business segment for the subject merchant and the previously identified business segment for the subject merchant differ by a threshold level, the subject merchant is labeled for further investigation to determine if fraudulent or criminal activity is present.

The systems and methods of the present disclosure use machine learning techniques to automatically and accurately determine the business segment associated with a merchant user of a data management system. In one embodiment, this information to then further utilized to identify potentially fraudulent or criminal activity. As a result, the systems and methods of the present disclosure can be used to: meet various legal reporting requirements; provide more relevant user experience; and more readily identify fraudulent/illegal activity. Consequently, the systems and methods of the present disclosure provide a technical solution to the long-standing technical problem of automatically, accurately, effectively, and efficiently identifying potentially fraudulent activity.

### BRIEF DESCRIPTION OF THE DRAWINGS

FIG. 1 is a high-level block diagram of a model training environment for training a machine learning-based merchant business segment prediction model in accordance with one embodiment.

FIG. 2 is a high-level block diagram of a runtime environment for implementing a method and system for business segment determination in accordance with one embodiment.

FIG. 3 is a high-level block diagram of a runtime environment for implementing a method and system for business segment determination and fraud detection in accordance with one embodiment.

FIG. 4 is a flow chart representing a process for training a machine learning-based merchant business segment prediction model in accordance with one embodiment.

FIG. 5 is a flow chart representing a process for business segment determination in accordance with one embodiment.

FIG. 6 is a flow chart representing a process for business segment determination and fraud detection in accordance with one embodiment.

Common reference numerals are used throughout the FIGs. and the detailed description to indicate like elements. One skilled in the art will readily recognize that the above FIGs. are merely illustrative examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying FIGs. which depict one or more exemplary embodiments. Embodiments may be implemented in many different forms and should not be construed as limited to the embodiments set forth herein, shown in the FIGs., and/or described below. Rather, these exemplary embodiments are provided to allow a complete disclosure that conveys the principles of the invention, as set forth in the claims, to those of skill in the art.

In accordance with the systems and methods of the present disclosure financial documents associated with categorized merchants who have previously been identified as merchants associated with specific business segments and business segment codes are collected and processed. This data is then used as training data for one or more merchant business segment prediction models using machine learning techniques.

Once the one or more merchant business segment prediction models are trained, current and historical financial documents associated with an uncategorized merchant are then collected and processed to generate uncategorized merchant financial document data. The uncategorized merchant financial document data is then provided to the trained one or more merchant business segment prediction models. The trained one or more merchant business segment prediction models then generate data indicating the probability that the uncategorized merchant is associated with one or more specific business segments and/or business segment codes. The specific business segment and/or business segment code determined to be most probably associated with the uncategorized merchant is then assigned to the previously uncategorized merchant. This assigned business segment and/or business segment code is then used to comply with various reporting requirements, provide the merchants with a customized user experience, and to detect fraudulent or other illegal activity.

In addition, in one embodiment, once the one or more merchant business segment prediction models are trained, the systems and methods of the present disclosure are used to identify fraudulent or criminal activity such as fraudulent merchants, criminal monetary transactions, and fake invoices. This is accomplished by collecting current and historical financial documents associated with a self-categorized, or previously categorized, “subject” merchant who has previously been associated with a specific business segment or code. The previously categorized merchant financial documents are then processed and provided to the trained one or more merchant business segment prediction models. The trained one or more merchant business segment prediction models then determine a specific business segment and/or business segment code most probably associated with the previously categorized subject merchant. This information is then compared with the previous business segment or code assigned to the previously categorized subject merchant. If the specific business segment and/or business segment code predicted by the one or more merchant business segment prediction models is not the same as the previous business segment or code of the previously categorized subject merchant, or is determined to be too different or inconsistent, then the previously categorized subject merchant is flagged and/or subjected to further analysis or investigation.

Consequently, the systems and methods of the present disclosure provide a technical solution to the technical problem of automatically, accurately, effectively, and efficiently determining the business segment associated with a merchant user of a data management system. In addition, the systems and methods of the present disclosure can be used to identify fraudulent activity such as fraudulent merchants, criminal monetary transactions, and fraudulent invoices.

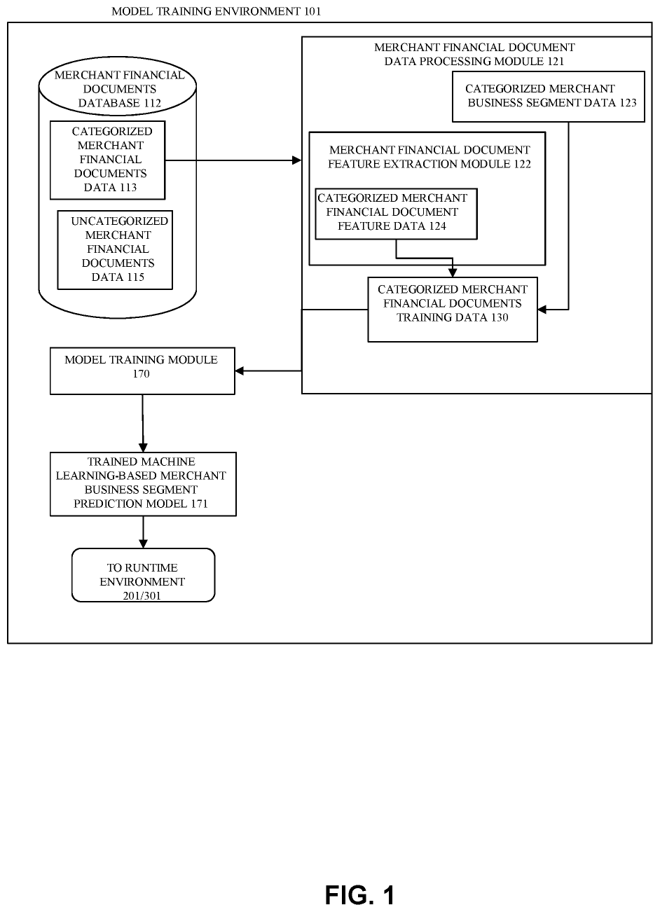

FIG. 1 is a high-level block diagram of a model training environment 101 for training a trained machine learning-based merchant business segment prediction model 171.

As seen in FIG. 1, model training environment 101 includes merchant financial documents database 112, merchant financial document data processing module 121, merchant financial document feature extraction module 122, model training module 170, and trained machine learning-based merchant business segment prediction model 171.

As seen in FIG. 1, merchant financial documents database 112 includes categorized merchant financial documents data 113 representing financial documents associated with categorized merchants who have previously been identified as merchants associated with specific business segments and business segment codes.

Categorized merchant financial documents data 113 typically includes data representing multiple individual documents such as, but not limited to, invoices generated by the categorized merchants; invoices received by the categorized merchants; estimates provided by the categorized merchants; inventory documents associated with the categorized merchants; revenue documents associated with the categorized merchants; accounting documents associated with the categorized merchants; correspondence documents associated with the categorized merchants; social media postings associated with the categorized merchants; website postings associated with the categorized merchants; domain names associated with the categorized merchants; email addresses associated with the categorized merchants; phone numbers associated with the categorized merchants; addresses associated with the categorized merchants; and any other document or business related document data associated with a merchant as discussed herein, known in the art at the time of filing, or as becomes known after the time of filing.

As seen in FIG. 1, merchant financial documents database 112 also includes uncategorized merchant financial documents data 115 representing financial documents associated with uncategorized merchants who have not previously been identified as merchants associated with specific business segments and business segment codes.

Like categorized merchant financial documents data 113, uncategorized merchant financial documents data 115 can include data representing numerous individual documents such as, but not limited to, invoices generated by the uncategorized merchants; invoices received by the uncategorized merchants; estimates provided by the uncategorized merchants; inventory documents associated with the uncategorized merchants; revenue documents associated with the uncategorized merchants; accounting documents associated with the uncategorized merchants; correspondence documents associated with the uncategorized merchants; social media postings associated with the uncategorized merchants; website postings associated with the uncategorized merchants; domain names associated with the uncategorized merchants; email addresses associated with the uncategorized merchants; phone numbers associated with the uncategorized merchants; addresses associated with the uncategorized merchants; and any other document or business related data associated with a merchant as discussed herein, known in the art at the time of filing, or as becomes known after the time of filing.

Categorized merchant financial documents data 113 and uncategorized merchant financial documents data 115 can be obtained from multiple sources including, but not limited to, one or more data management systems associated with model training environment 101. Many data management systems, including, but not limited to, small business data management systems, personal financial data management systems, transaction data management systems, and the like, offer various financial document preparation and submission capabilities such as billing, bill payment, estimates, inventory, and other financial document creation and dissemination capabilities, to the users of these data management systems. Consequently, in one example, at least part of categorized merchant financial documents data 113 and uncategorized merchant financial documents data 115 is obtained by collecting various financial documents generated by, submitted to, or processed through, one or more data management systems by merchant users of the data management systems.

In some cases, categorized merchant financial documents data 113 and uncategorized merchant financial documents data 115 are generated outside of the data management system and are either submitted by a merchant user of the data management system or are uploaded by a customer or other user of the data management system.

In some cases, categorized merchant financial documents data 113 and uncategorized merchant financial documents data 115 are obtained from data processed and generated by machine learning-based merchant business segment prediction models, such as trained machine learning-based merchant business segment prediction model 171.

In some cases categorized merchant financial documents data 113 and uncategorized merchant financial documents data 115 come from any or all sources of categorized merchant financial documents data 113 and uncategorized merchant financial documents data 115 discussed herein, or known in the art at the time of filing, or as become known after the time of filing.

As seen in FIG. 1, categorized merchant financial documents data 113 is provided to merchant financial document data processing module 121. At merchant financial document data processing module 121 one or more methods are used to identify and extract categorized merchant business segment data 123.

In various embodiments, extracted categorized merchant business segment data 123 includes data indicating the business segment associated with the categorized merchants of categorized merchant financial documents data 113. In various embodiments, categorized merchant business segment data 123 represents a business code associated with the categorized merchants of categorized merchant financial documents data 113 such as a North American Industry Classification System (NAICS) code, a Merchant Category Code system (MCC) code, or any code used with any standardized business segment classification systems as discussed herein, or known in the art at the time of filing, or as become known after the time of filing.

As seen in FIG. 1, merchant financial document data processing module 121 includes merchant financial document feature extraction module 122. Merchant financial document feature extraction module 122 is used to identify, extract, and collect categorized merchant financial document feature data 124. In various embodiments, categorized merchant financial document feature data 124 includes textual and non-textual features in categorized merchant financial documents data 113 such as words, phrases, symbols, numbers etc.

The merchant financial document features identified and extracted by merchant financial document feature extraction module 122 can be pre-defined, or pre-identified, as features, or data elements, associated with merchant financial documents that, depending on the present, absence, or state, of the features can be indicative of a business segment associated with each financial document. In some cases, the merchant financial document features are defined by analysis of historically known merchant financial documents and business segments and the elements of those financial documents that were found to be indicative, or not indicative, of the specific business segment. In some cases, the merchant financial document features are defined by analysis performed by human analysts. In other cases, the merchant financial document features are defined and identified by virtue of the processing of categorized merchant financial documents data 113 by one or more processing modules including, but not limited to, one or more machine learning-based models. In some cases, the merchant financial document features are defined and identified by machine learning-based merchant business segment prediction models, such as trained machine learning-based merchant business segment prediction model 171.

In one example, Optical Character Recognition (OCR) techniques are used by merchant financial document feature extraction module 122 to identify and extract the categorized merchant financial document feature data 124 and categorized merchant business segment data 123 associated with each of the financial documents included in the categorized merchant financial documents data 113. Various OCR systems and techniques are well known to those of skill in the art. Consequently, a more detailed description of the operation of any specific OCR technique used to identify and extract categorized merchant financial document feature data 124 and categorized merchant business segment data 123 associated with each of the financial documents included in categorized merchant financial documents data 113 is omitted here to avoid detracting from the invention.

Returning to FIG. 1, in order for merchant financial document feature extraction module 122 to identify the features present in a given invoice of categorized merchant financial documents data 113 it is important that categorized merchant financial document feature data 124 and categorized merchant business segment data 123 be processed by one or more methods to indicate not only that the merchant financial document feature is present, but also the location of the merchant financial document feature data in the merchant financial document data. In one example, this is accomplished by using a combination of OCR techniques discussed above and JavaScript Object Notation (JSON).

JSON is an open-standard file format that uses human readable text to transmit data objects consisting of attribute-value pairs and array data types. Importantly, when text is converted into JSON file format each object in the text is described as an object at a very precise location in the text document. Consequently, when text data, such as categorized merchant financial documents data 113 and uncategorized merchant financial documents data 115, is converted into JSON file format, the name of the potential merchant financial document feature is indicated as the object and the precise location of the object and data associated with that object in the vicinity of the object is indicated. Consequently, by converting categorized merchant financial documents data 113 and uncategorized merchant financial documents data 115 into a JSON file format, the identification of the merchant financial document features within the merchant financial document data is a relatively trivial task. JSON is well known to those of skill in the art, therefore a more detailed discussion of JSON, and JSON file formatting, is omitted here to avoid detracting from the invention.

Once the merchant financial document features are identified and extracted as merchant financial document feature data for each financial document represented in categorized merchant financial documents data 113 by merchant financial document feature extraction module 122, the merchant financial document feature data for all of the financial documents represented in categorized merchant financial documents data 113 is collected as categorized merchant financial document feature data 124.

As seen in FIG. 1, once categorized merchant financial document feature data 124 and categorized merchant business segment data 123 is generated, categorized merchant financial document feature data 124 and categorized merchant business segment data 123 are correlated to generate categorized merchant financial documents training data 130. Categorized merchant financial documents training data 130 can include categorized merchant financial document feature data 124 and categorized merchant business segment data 123 arranged in a machine learning-based merchant business segment prediction model training data matrix and used as training data to train a supervised machine learning-based merchant business segment prediction model. In this case, rows of feature data from categorized merchant financial document feature data 124 represent categorized merchant financial document feature vector data associated with each categorized merchant financial document and are used as input objects by model training module 170 to train a machine learning-based merchant business segment prediction model. In these supervised learning examples, categorized merchant business segment data 123 are arranged as entries in a label column and are used as supervisory signals, or labels.

Categorized merchant financial documents training data 130 is then provided to model training module 170 where it is used as training data to generate trained machine learning-based merchant business segment prediction model 171. In this case, the rows of categorized merchant financial document feature data 124 represent categorized merchant document feature vector data associated with each categorized merchant document and are used as input objects by model training module 170 to train a machine learning-based merchant business segment prediction model. In these supervised learning examples, the data entries from categorized merchant business segment data 123 are arranged in a label column and are used as supervisory signals, or labels.

Those of skill in the art will recognize that, in practice, categorized merchant financial documents training data 130 may include, hundreds, thousands, or millions of rows representing hundreds, thousands, or millions of known merchant business segments and that more rows can be added representing more business segments as those business segments are identified and associated with categorized merchant document features.

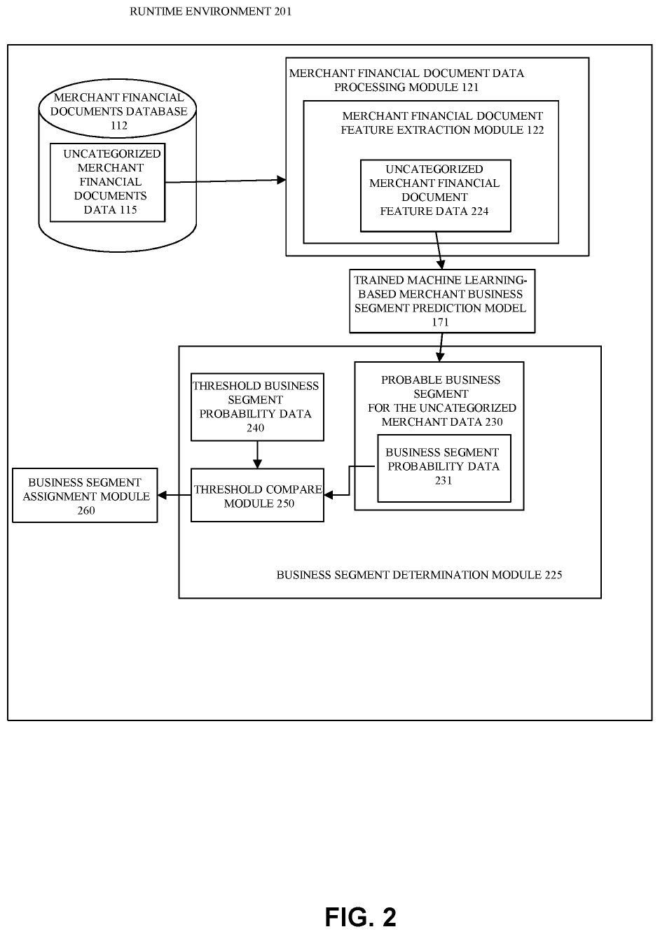

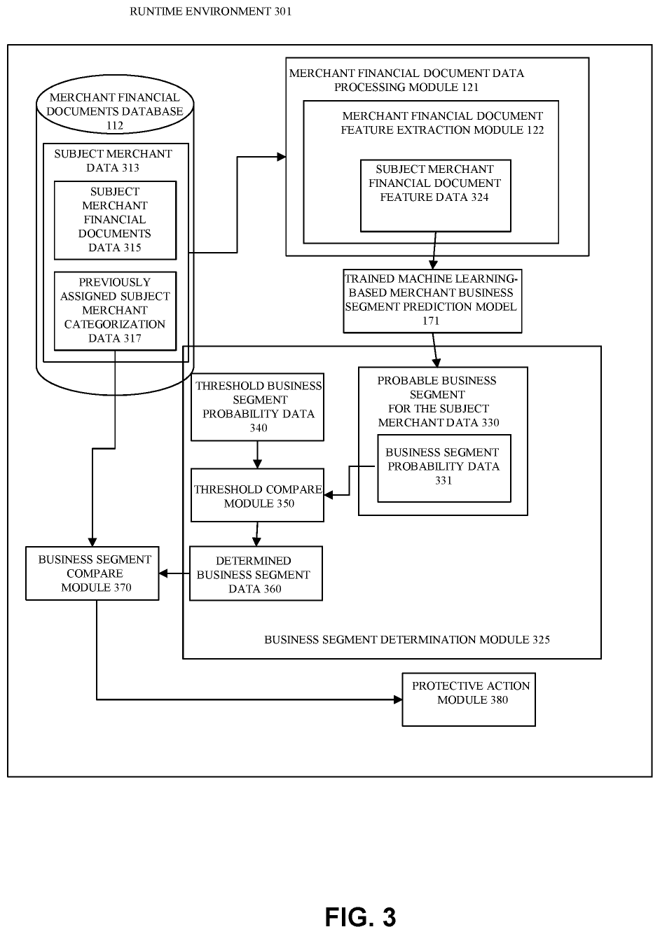

As discussed in more detail below, once trained machine learning-based merchant business segment prediction model 171 is generated, trained machine learning-based merchant business segment prediction model 171 is deployed in a runtime environment, such as runtime environment 201 of FIG. 2 or runtime environment 301 of FIG. 3. As also discussed below, once implemented in a runtime environment, trained machine learning-based merchant business segment prediction model 171 is used to generate probable business segment data for merchants based on merchant financial document data associated with the merchants.

FIG. 2 is a high-level block diagram of a runtime environment 201 for implementing a method and system for business segment determination in accordance with one embodiment.

As seen in FIG. 2, runtime environment 201 includes merchant financial documents database 112, merchant financial document data processing module 121, merchant financial document feature extraction module 122, trained machine learning-based merchant business segment prediction model 171, business segment determination module 225, and business segment assignment module 260.

As seen in FIG. 2, merchant financial documents database 112 includes uncategorized merchant financial documents data 115 representing financial documents associated with uncategorized merchants who have not previously been identified as merchants associated with specific business segments and business segment codes.

As discussed above, uncategorized merchant financial documents data 115 can include data representing numerous individual documents such as, but not limited to, invoices generated by the uncategorized merchants; invoices received by the uncategorized merchants; estimates provided by the uncategorized merchants; inventory documents associated with the uncategorized merchants; revenue documents associated with the uncategorized merchants; accounting documents associated with the uncategorized merchants; correspondence documents associated with the uncategorized merchants; social media postings associated with the uncategorized merchants; website postings associated with the uncategorized merchants; domain names associated with the uncategorized merchants; email addresses associated with the uncategorized merchants; phone numbers associated with the uncategorized merchants; addresses associated with the uncategorized merchants; and any other document or business related data associated with a merchant as discussed herein, known in the art at the time of filing, or as becomes known after the time of filing.

As discussed above, uncategorized merchant financial documents data 115 can be obtained from multiple sources including, but not limited to, one or more data management systems associated with runtime environment 201. Consequently, in one example, at least part of uncategorized merchant financial documents data 115 is obtained by collecting various financial documents generated by, submitted to, or processed through, one or more data management systems by merchant users of the data management systems.

In some cases, uncategorized merchant financial documents data 115 is generated outside of the data management system and is either submitted by a merchant user of the data management system or is uploaded by a customer or other user of the data management system.

In some cases, uncategorized merchant financial documents data 115 is obtained from data processed and generated by machine learning-based merchant business segment prediction models, such as trained machine learning-based merchant business segment prediction model 171.

In some cases uncategorized merchant financial documents data 115 comes from any or all sources of categorized merchant financial documents data 113 and uncategorized merchant financial documents data 115 discussed herein, or known in the art at the time of filing, or as become known after the time of filing.

As seen in FIG. 2, uncategorized merchant financial documents data 115 is provided to merchant financial document data processing module 121. As discussed above, merchant financial document data processing module 121 includes merchant financial document feature extraction module 122. Merchant financial document feature extraction module 122 is used to identify, extract, and collect uncategorized merchant financial document feature data 224. In various embodiments, uncategorized merchant financial document feature data 224 includes textual and non-textual features in uncategorized merchant financial documents data 115 such as words, phrases, symbols, numbers etc.

As discussed above, the merchant financial document features identified and extracted by merchant financial document feature extraction module 122 can be pre-defined, or pre-identified, as features, or data elements, associated with merchant financial documents that, depending on the present, absence, or state, of the features can be indicative of a business segment associated with each financial document. In some cases, the merchant financial document features are defined by analysis of historically known merchant financial documents and business segments and the elements of those financial documents that were found to be indicative, or not indicative, of the specific business segment. In some cases, the merchant financial document features are defined by analysis performed by human analysts. In other cases, the merchant financial document features are defined and identified by virtue of the processing of uncategorized merchant financial documents data 115 by one or more processing modules including, but not limited to, one or more machine learning-based models. In some cases, the merchant financial document features are defined and identified by machine learning-based merchant business segment prediction models, such as trained machine learning-based merchant business segment prediction model 171.

As noted above, in one example, Optical Character Recognition (OCR) techniques and/or JSON formatting are used by merchant financial document feature extraction module 122 to identify and extract the uncategorized merchant financial document feature data 224 associated with each of the financial documents included in the uncategorized merchant financial documents data 115. Various OCR systems and techniques are well known to those of skill in the art.

Once the uncategorized merchant financial document features are identified and extracted as uncategorized merchant financial document feature data for each financial document represented in uncategorized merchant financial documents data 115 by merchant financial document feature extraction module 122, the uncategorized merchant financial document feature data for all of the financial documents represented in uncategorized merchant financial documents data 115 is collected as uncategorized merchant financial document feature data 224.

As seen in FIG. 1, once uncategorized merchant financial document feature data 224 is generated, uncategorized merchant financial document feature data 224 is provided to trained machine learning-based merchant business segment prediction model 171. Trained machine learning-based merchant business segment prediction model 171 can be a machine learning-based merchant business segment prediction model trained as described above with respect to FIG. 1 and the description of model training environment 101.

Once uncategorized merchant financial document feature data 224 is provided to trained machine learning-based merchant business segment prediction model 171, trained machine learning-based merchant business segment prediction model 171 generates probable business segment for the uncategorized merchant data 230. Probable business segment for the uncategorized merchant data 230 includes data indicating one or more business segments associated with the uncategorized merchant.

In various embodiments, probable business segment for the uncategorized merchant data 230 represents one or more business codes determined to be associated with the uncategorized merchant of uncategorized merchant financial documents data 115 such as a North American Industry Classification System (NAICS) code, a Merchant Category Code system (MCC) code, or any code used with any standardized business segment classification systems as discussed herein, or known in the art at the time of filing, or as become known after the time of filing.

Probable business segment for the uncategorized merchant data 230 can also include business segment probability data 231 indicating the probability that the uncategorized merchant is associated with each specific business segment and/or business segment code indicated in probable business segment for the uncategorized merchant data 230. In various embodiments, business segment probability data 231 can represent a business segment probability score for each specific business segment and/or business segment code indicated in probable business segment for the uncategorized merchant data 230.

When probable business segment for the uncategorized merchant data 230 includes business segment probability data 231, the value or score indicated by business segment probability data 231 is compared at threshold compare module 250 to a predetermined threshold business segment probability represented by threshold business segment probability data 240.

If a business segment probability or probability score for a specific business segment represented by business segment probability data 231 is greater than a threshold business segment probability or probability score represented by threshold business segment probability data 240, then the specific business segment is assigned to the previously uncategorized merchant at business segment assignment module 260.

Once a specific business segment is assigned to the previously uncategorized merchant at business segment assignment module 260, then the business segment determined and assigned to the previously uncategorized merchant is used to dictate various actions to be performed with respect to the now newly categorized merchant. These actions can include, but are not limited to, ensuring legal reporting requirements associated with the business segment determined and assigned to the previously uncategorized merchant are met; customizing a data management system user experience provided to the previously uncategorized merchant based on the business segment determined and assigned to the previously uncategorized merchant, and, as discussed in more detail below, to identify and prevent fraudulent/illegal activity.

As noted above, the methods and systems disclosed herein can be used to identify fraudulent or criminal activity such as fraudulent merchants, criminal monetary transactions, and fake invoices.

As one example of using the methods and systems disclosed herein to identify fraudulent or criminal activity, once the one or more merchant business segment prediction models are trained, the systems and methods of the present disclosure can be used to identify fraudulent or criminal activity by obtaining a current or historical financial document associated with a self-categorized merchant who has previously provided a specific business segment or code. The self-categorized merchant financial document is then processed to generate self-categorized merchant financial document data. The self-categorized merchant financial document data is then provided to the trained one or more merchant business segment prediction models. The trained one or more merchant business segment prediction models then generate data indicating the probability that the self-categorized merchant financial document is associated with a specific business segment and/or business segment code. This data is then compared with the self-categorization data provided by the self-categorized merchant. If the specific business segment and/or business segment code predicted by the one or more merchant business segment prediction models to be associated with the merchant financial document data is not the same as the self-categorization data provided by the self-categorized merchant, or is determined to be too different or inconsistent, then the self-categorized merchant is flagged and/or subjected to further analysis or investigation.

As another example of using the methods and systems disclosed herein to identify fraudulent or criminal activity, once the one or more merchant business segment prediction models are trained, the systems and methods of the present disclosure are used to identify fraudulent or criminal activity by collecting a current or historical financial document associated with a categorized merchant who has previously been assigned or has provided a specific business segment or code. The categorized merchant financial document is then processed to generate categorized merchant financial document data. The categorized merchant financial document data is then provided to the trained one or more merchant business segment prediction models. The trained one or more merchant business segment prediction models then generate data indicating the probability that the categorized merchant financial document is associated with a specific business segment and/or business segment code. This data is then compared with the categorization data currently associated with the categorized merchant. If the specific business segment and/or business segment code predicted by the one or more merchant business segment prediction models to be associated with the merchant financial document data is not the same as the current categorization data for the categorized merchant, or is determined to be too different or inconsistent, then the categorized merchant is flagged and/or subjected to further analysis or investigation.

In one embodiment, once the one or more merchant business segment prediction models are trained, the systems and methods of the present disclosure are used to identify fraudulent or criminal activity by collecting current and historical financial documents associated with a subject merchant who can be a previously categorized merchant, such as a self-categorized merchant, who has previously been assigned a specific business segment or code. The subject merchant financial documents are then processed to generate subject merchant financial document data. The subject merchant financial document data is then provided to the trained one or more merchant business segment prediction models. The trained one or more merchant business segment prediction models then generate data indicating the probability that the subject merchant is associated with a specific business segment and/or business segment code. This data is then compared with the previously assigned or self-provided categorization data. If the specific business segment and/or business segment code predicted by the one or more merchant business segment prediction models is not the same as the previously assigned or self-provided business segment, or is determined to be too different or inconsistent, then the subject merchant is flagged and/or subjected to further analysis or investigation.

FIG. 3 is a high-level block diagram of a runtime environment for implementing a method and system for business segment determination and fraud detection in accordance with one embodiment.

As seen in FIG. 3, runtime environment 301 includes merchant financial documents database 112, merchant financial document data processing module 121, merchant financial document feature extraction module 122, trained machine learning-based merchant business segment prediction model 171, business segment determination module 325, business segment compare module 370, and protective action module 380.

As seen in FIG. 3, merchant financial documents database 112 includes subject merchant data 313. The subject merchant of FIG. 3 can be a merchant being analyzed to confirm the subject merchant is associated with the correct business segment. In various embodiments, the subject merchant may be selected for analysis based on random selection, periodic review, or any indication that the subject merchant may not be associated with the correct business segment.

Subject merchant data 313 can include subject merchant financial documents data 315 representing financial documents associated with the subject merchant and previously assigned subject merchant categorization data 317 representing the previously assigned/reported business segment associated with the subject merchant.

In some cases, the previously assigned/reported business segment associated with the subject merchant represented by previously assigned subject merchant categorization data 317 may have been self-reported by the subject merchant. In some cases, the previously assigned/reported business segment associated with the subject merchant represented by subject merchant categorization data 317 may have been assigned to the subject merchant.

The previously assigned/reported business segment associated with the subject merchant represented by previously assigned subject merchant categorization data 317 can be in the form of a business segment code such as a North American Industry Classification System (NAICS) code, a Merchant Category Code system (MCC) code, or any code used with any standardized business segment classification systems as discussed herein, or known in the art at the time of filing, or as become known after the time of filing.

Subject merchant financial documents data 315 can include data representing numerous individual documents such as, but not limited to, invoices generated by the subject merchant; invoices received by the subject merchant; estimates provided by the subject merchant; inventory documents associated with the subject merchant; revenue documents associated with the subject merchant; accounting documents associated with the subject merchant; correspondence documents associated with the subject merchant; social media postings associated with the subject merchant; website postings associated with the subject merchant; domain names associated with the subject merchant; email addresses associated with the subject merchant; phone numbers associated with the subject merchant; addresses associated with the subject merchant; and any other document or business related data associated with a merchant as discussed herein, known in the art at the time of filing, or as becomes known after the time of filing.

Subject merchant financial documents data 315 can be obtained from multiple sources including, but not limited to, one or more data management systems associated with runtime environment 301. Consequently, in one example, at least part of subject merchant financial documents data 315 is obtained by collecting various financial documents generated by, submitted to, or processed through, data management systems by subject merchant users of the data management systems.

In some cases, subject merchant financial documents data 315 is generated outside of the data management system and is either submitted by a subject merchant user of the data management system or is uploaded by a customer or other user of the data management system.

In some cases, subject merchant financial documents data 315 comes from any or all sources of subject merchant financial documents data 315 discussed herein, or known in the art at the time of filing, or as become known after the time of filing.

As seen in FIG. 3, subject merchant financial documents data 315 is provided to merchant financial document data processing module 121. As discussed above, merchant financial document data processing module 121 includes merchant financial document feature extraction module 122. Merchant financial document feature extraction module 122 is used to identify, extract, and collect subject merchant financial document feature data 324. In various embodiments, subject merchant financial document feature data 324 includes textual and non-textual features in subject merchant financial documents data 315 such as words, phrases, symbols, numbers etc.

As discussed above, the merchant financial document features identified and extracted by merchant financial document feature extraction module 122 can be pre-defined, or pre-identified, as features, or data elements, associated with merchant financial documents that, depending on the present, absence, or state, of the features can be indicative of a business segment associated with each financial document. In some cases, the merchant financial document features are defined by analysis of historically known merchant financial documents and business segments and the elements of those financial documents that were found to be indicative, or not indicative, of the specific business segment. In some cases, the merchant financial document features are defined by analysis performed by human analysts. In other cases, the merchant financial document features are defined and identified by virtue of the processing of subject merchant financial documents data 315 by one or more processing modules including, but not limited to, one or more machine learning-based models. In some cases, the merchant financial document features are defined and identified by machine learning-based merchant business segment prediction models, such as trained machine learning-based merchant business segment prediction model 171.

As noted above, in one example, Optical Character Recognition (OCR) techniques and/or JSON formatting are used by merchant financial document feature extraction module 122 to identify and extract the subject merchant financial document feature data 324 associated with each of the financial documents included in the subject merchant financial documents data 315. Various OCR systems and techniques are well known to those of skill in the art.

Once the subject merchant financial document features are identified and extracted as subject merchant financial document feature data for each financial document represented in subject merchant financial documents data 315 by merchant financial document feature extraction module 122, the subject merchant financial document feature data for all of the financial documents represented in subject merchant financial documents data 315 is collected as subject merchant financial document feature data 324.

As seen in FIG. 3, once subject merchant financial document feature data 324 is generated, subject merchant financial document feature data 324 is provided to trained machine learning-based merchant business segment prediction model 171. Trained machine learning-based merchant business segment prediction model 171 can be a machine learning-based merchant business segment prediction model trained as described above with respect to FIG. 1 and the description of model training environment 101.

Once subject merchant financial document feature data 324 is provided to trained machine learning-based merchant business segment prediction model 171, trained machine learning-based merchant business segment prediction model 171 generates probable business segment for the subject merchant data 330. Probable business segment for the subject merchant data 330 includes data indicating one or more business segments associated with the subject merchant.

In various embodiments, probable business segment for the subject merchant data 330 represents one or more business codes determined to be associated with the uncategorized merchant of subject merchant financial documents data 315 such as a North American Industry Classification System (NAICS) code, a Merchant Category Code system (MCC) code, or any code used with any standardized business segment classification systems as discussed herein, or known in the art at the time of filing, or as become known after the time of filing.

Probable business segment for the subject merchant data 330 can also include business segment probability data 331 indicating the probability that the subject merchant is associated with each specific business segment and/or business segment code indicated in probable business segment for the subject merchant data 330. In various embodiments, business segment probability data 331 can represent a business segment probability score for each specific business segment and/or business segment code indicated in probable business segment for the subject merchant data 330.

When probable business segment for the subject merchant data 330 includes business segment probability data 331, the value or score indicated by business segment probability data 331 is compared at threshold compare module 350 to a predetermined threshold business segment probability represented by threshold business segment probability data 340.

If a business segment probability or probability score for a specific business segment represented by business segment probability data 331 is greater than a threshold business segment probability or probability score represented by threshold business segment probability data 340, then determined business segment data 360 is generated representing that specific business segment.

Once determined business segment data 360 is generated for the subject merchant, determined business segment data 360 and previously assigned subject merchant categorization data 317 are provided to business segment compare module 370.

At business segment compare module 370 the determined business segment represented by determined business segment data 360 is compared to the previously assigned business segment represented by previously assigned subject merchant categorization data 317. If the determined business segment represented by determined business segment data 360 differs from the previously assigned business segment represented by previously assigned subject merchant categorization data 317 by a threshold amount/level, then one or more protective actions are taken at protective action module 380 to identify and prevent fraudulent or other criminal activity.

The one or more protective actions that can be taken by protective action module 380 include, but are not limited to, contacting the subject merchant to clarify the discrepancy in business segment assignment; assigning the newly determined business segment to the subject merchant; suspending all subject merchant activity within a data management system used by the subject merchant until the discrepancy in business segment assignment is resolved; sending financial document data associated with the subject merchant to a fraud/criminal activity specialist for analysis; closing down any accounts within a data management system used by the subject merchant; or any other protective action as discussed herein, or known at the time of filing, or that become known after the time of filing.

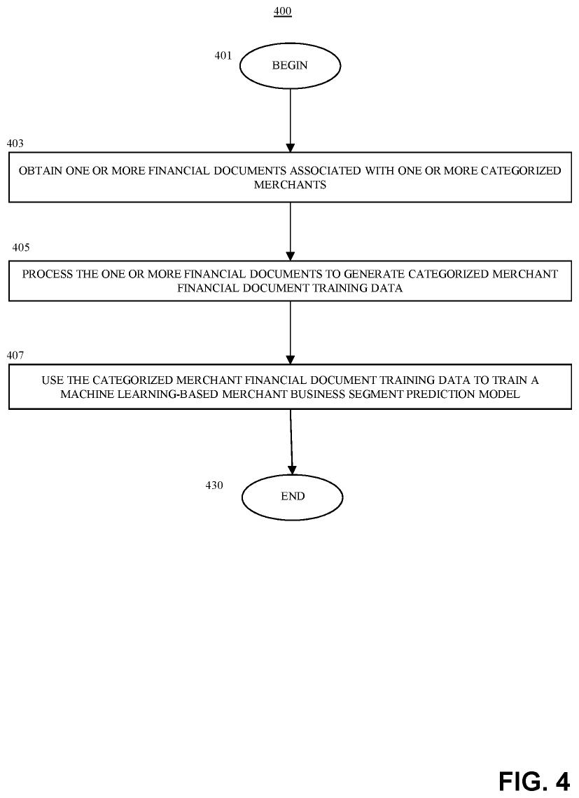

FIG. 4 is a flow chart representing a process 400 for training a machine learning-based merchant business segment prediction model in accordance with one embodiment.

Referring to FIGS. 1 and 4 together, process 400 begins at operation 401 and process flow proceeds to operation 403.

At operation 403 one or more financial documents associated with one or more categorized merchants, such as any of the financial documents discussed above with respect to FIG. 1, are obtained using any of the sources or methods discussed above with respect to FIG. 1.

Once one or more financial documents associated with one or more categorized merchants are obtained at operation 403, process flow proceeds to operation 405.

At operation 405, the financial documents associated with one or more categorized merchants are processed by any of the methods discussed above with respect to FIG. 1 to generate categorized merchant financial document training data such as any of the categorized merchant financial document training data discussed above with respect to FIG. 1.

Once categorized merchant financial document training data is generated at operation 405, process flow proceeds to operation 407.

At operation 407, the categorized merchant financial document training data is used to train a machine learning-based merchant business segment prediction model used to generate probable business segment data for merchants based on merchant financial document data associated with the merchants using any of the methods discussed above with respect to FIG. 1.

Once a machine learning-based merchant business segment prediction model is trained to generate probable business segment data for merchants based on merchant financial document data associated with the merchants at operation 407, process flow proceeds to end operation 430. At end operation 430, process 400 is exited to await new data.

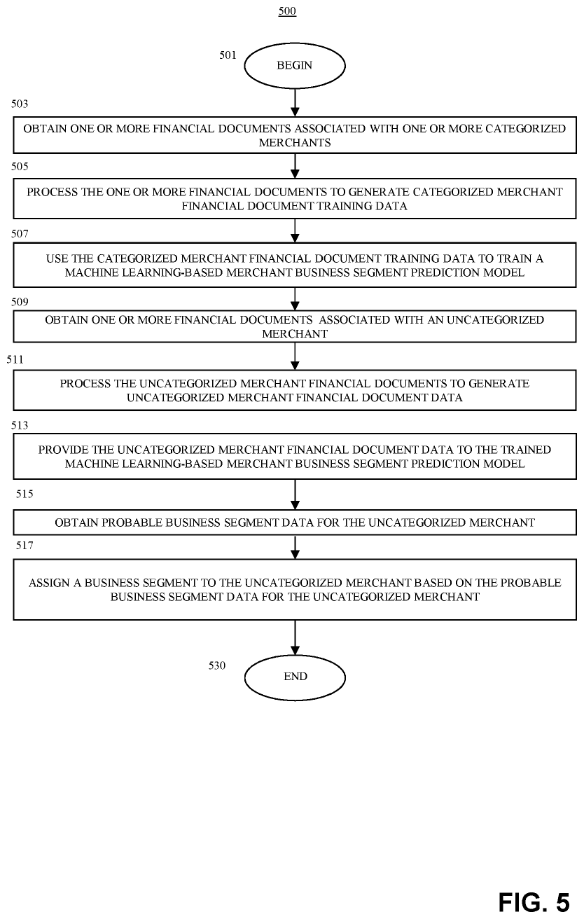

FIG. 5 is a flow chart representing a process 500 for business segment determination in accordance with one embodiment.

Referring to FIGS. 1, 2 and 5 together, process 500 begins at operation 501 and process flow proceeds to operation 503.

At operation 503 one or more financial documents associated with one or more categorized merchants, such as any of the financial documents discussed above with respect to FIG. 1, are obtained using any of the sources or methods discussed above with respect to FIG. 1.

Once one or more financial documents associated with one or more categorized merchants are obtained at operation 503, process flow proceeds to operation 505.

At operation 505, the financial documents associated with one or more categorized merchants are processed by any of the methods discussed above with respect to FIG. 1 to generate categorized merchant financial document training data such as any of the categorized merchant financial document training data discussed above with respect to FIG. 1.

Once categorized merchant financial document training data is generated at operation 505, process flow proceeds to operation 507.

At operation 507, the categorized merchant financial document training data is used to train a machine learning-based merchant business segment prediction model used to generate probable business segment data for merchants based on merchant financial document data associated with the merchants using any of the methods discussed above with respect to FIG. 1.

Once a machine learning-based merchant business segment prediction model is trained to generate probable business segment data for merchants based on merchant financial document data associated with the merchants at operation 507, process flow proceeds to operation 509.

At operation 509 one or more financial documents associated with an uncategorized merchant, such as any of the financial documents discussed above with respect to FIG. 1 and FIG. 2, are obtained using any of the sources or methods discussed above with respect to FIG. 1 and FIG. 2.

Once one or more financial documents associated with an uncategorized merchant are obtained at operation 509, process flow proceeds to operation 511.

At operation 511, the one or more financial documents associated with an uncategorized merchant of operation 509 are processed to generate uncategorized merchant financial document data using any of the methods discussed above with respect to FIG. 2.

Once uncategorized merchant financial document data is generated at operation 511, process flow proceeds to operation 513.

At operation 513, the uncategorized merchant financial document data of operation 511 is provided to the trained machine learning-based merchant business segment prediction model of operation 507.

Once the uncategorized merchant financial document data is provided to the trained machine learning-based merchant business segment prediction model at operation 513, process flow proceeds to operation 515.

At operation 515, the trained machine learning-based merchant business segment prediction model of operation 507 uses the uncategorized merchant financial document data of operation 511 to determine one or more probable business segments for the uncategorized merchant and generate probable business segment data for the uncategorized merchant using any of the methods discussed above with respect to FIG. 2.

Once probable business segment data is generated for the uncategorized merchant at operation 515, process flow proceeds to operation 517.

At operation 517, a business segment is assigned to the uncategorized merchant based, at least in part, on the probably business segment data generated for the uncategorized merchant at operation 515.

Once a business segment is assigned to the uncategorized merchant at operation 517, process flow proceeds to end operation 530. At end operation 530, process 500 is exited to await new data.

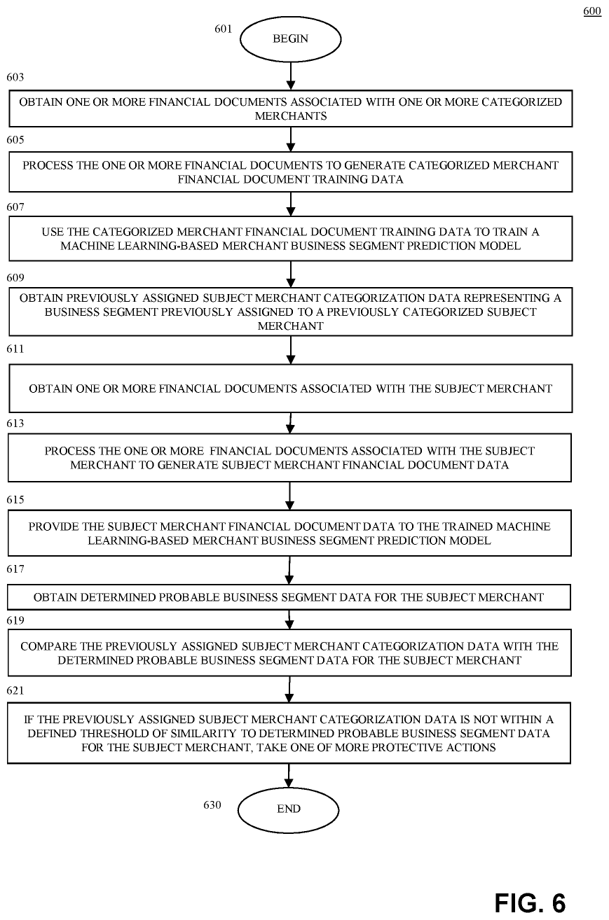

FIG. 6 is a flow chart representing a process 600 for business segment determination and fraud detection in accordance with one embodiment.

Referring to FIGS. 1, 3 and 6 together, process 600 begins at operation 601 and process flow proceeds to operation 603.

At operation 603 one or more financial documents associated with one or more categorized merchants, such as any of the financial documents discussed above with respect to FIG. 1, are obtained using any of the sources or methods discussed above with respect to FIG. 1.

Once one or more financial documents associated with one or more categorized merchants are obtained at operation 603, process flow proceeds to operation 605.

At operation 605, the financial documents associated with one or more categorized merchants are processed by any of the methods discussed above with respect to FIG. 1 to generate categorized merchant financial document training data such as any of the categorized merchant financial document training data discussed above with respect to FIG. 1.

Once categorized merchant financial document training data is generated at operation 605, process flow proceeds to operation 607.

At operation 607, the categorized merchant financial document training data is used to train a machine learning-based merchant business segment prediction model used to generate probable business segment data for subject merchants based on subject merchant financial document data associated with the subject merchants using any of the methods discussed above with respect to FIG. 1.

Once a machine learning-based merchant business segment prediction model is trained to generate probable business segment data for subject merchants based on subject merchant financial document data associated with the subject merchants at operation 607, process flow proceeds to operation 609.

At operation 609 previously assigned subject merchant categorization data, such as any of the previously assigned subject merchant categorization data discussed above with respect to FIG. 3, is obtained that represents a business segment previously assigned to a subject merchant.

Once previously assigned subject merchant categorization data is obtained at operation 609, process flow proceeds to operation 611.

At operation 611, one or more financial documents associated with a subject merchant, such as any of the financial documents discussed above with respect to FIG. 1 and FIG. 3, are obtained using any of the sources or methods discussed above with respect to FIG. 1 and FIG. 3.

Once one or more financial documents associated with a subject merchant are obtained at operation 611, process flow proceeds to operation 613.

At operation 613, the one or more financial documents associated with the subject merchant of operation 611 are processed to generate subject merchant financial document data using any of the methods discussed above with respect to FIG. 3.

Once subject merchant financial document data is generated at operation 613, process flow proceeds to operation 615.

At operation 615, the subject merchant financial document data of operation 613 is provided to the trained machine learning-based merchant business segment prediction model of operation 607.

Once the subject merchant financial document data is provided to the trained machine learning-based merchant business segment prediction model at operation 615, process flow proceeds to operation 617.

At operation 617, the trained machine learning-based merchant business segment prediction model of operation 607 uses the subject merchant financial document data of operation 613 to determine one or more probable business segments for the subject merchant and generate probable business segment data for the subject merchant using any of the methods discussed above with respect to FIG. 3.

Once probable business segment data is generated for the subject merchant at operation 617, process flow proceeds to operation 619.

At operation 619, the determined probable business segment data for the subject merchant of operation 617 is compared to the previously assigned subject merchant categorization data of operation 609 using any of the methods discussed above with respect to FIG. 3.

Once the determined probable business segment data for the subject merchant is compared to the previously assigned subject merchant categorization data for the subject merchant at operation 619, process flow proceeds to operation 621.

At operation 621, if the determined business segment represented by determined probable business segment data for the subject merchant of operation 617 differs from the previously assigned business segment represented by the previously assigned subject merchant categorization data for the subject merchant of operation 609 by a threshold amount/level, then one or more protective actions are taken to identify and prevent fraudulent or other criminal activity.

Once, if the determined business segment differs from the previously assigned business segment by a threshold amount/level, one or more protective actions are taken to identify and prevent fraudulent or other criminal activity at operation 621, process flow proceeds to end operation 630. At end operation 630, process 600 is exited to await new data.

In the discussion above, certain aspects of one embodiment include process steps and/or operations and/or instructions described herein for illustrative purposes in a specific order and/or grouping. However, the specific order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the specific order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various users under numerous circumstances.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

In addition, the operations shown in the FIGs., or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method comprising:
obtaining categorized merchant financial documents data representing one or more financial documents associated with one or more categorized merchants, each of the one or more categorized merchants having been identified as conducting business in a respective business segment;
processing the categorized merchant financial documents data and generating categorized merchant financial document training data by correlating features of the categorized merchant financial documents data for each of the categorized merchants with the respective business segment associated with each of the categorized merchants;
using the categorized merchant financial document training data to train a machine learning-based merchant business segment prediction model to determine business segment probability scores based on merchant financial document data;
obtaining uncategorized merchant financial document data representing financial documents associated with an uncategorized merchant, the uncategorized merchant not having been identified as conducting business in a respective business segment;
providing the uncategorized merchant financial document data to the trained machine learning-based merchant business segment prediction model;
determining, using the machine learning-based merchant business segment prediction model, a probable business segment for the uncategorized merchant; and
assigning the determined probable business segment for the uncategorized merchant to the previously uncategorized merchant.

2. The computing system implemented method of claim 1 wherein the one or more financial documents include one or more financial documents selected from the set of financial documents comprising:
invoices generated by the merchants;
invoices received by the merchants;
estimates provided by the merchants;
inventory documents associated with the merchants;
revenue documents associated with the merchants;
accounting documents associated with the merchants;
correspondence documents associated with the merchants;
social media postings associated with the merchants;
website postings associated with the merchants;
domain names associated with the merchants;
email addresses associated with the merchants;
phone numbers associated with the merchants; and
addresses associated with the merchants.

3. The computing system implemented method of claim 1 wherein processing the categorized merchant financial documents data to generate categorized merchant financial document training data includes:
processing the categorized financial document data for each categorized merchant to identify and extract financial document feature data representing one or more financial document features and labeling the financial document feature data with the respective business segment data representing the business segment associated with that categorized merchant; and
using the extracted financial document feature data and business segment data to train the machine learning-based merchant business segment prediction model to generate a probable business segment score for uncategorized merchant indicating a probability that the uncategorized merchant is conducting business in one or more specific business categories.

4. The computing system implemented method of claim 3 wherein the machine learning-based merchant business segment prediction model is a supervised machine learning-based merchant business segment prediction model.

5. The computing system implemented method of claim 3 wherein the machine learning-based merchant business segment prediction model is an unsupervised machine learning-based merchant business segment prediction model.

6. The computing system implemented method of claim 3 wherein providing the uncategorized merchant financial document data to the trained machine learning-based merchant business segment prediction model further comprises:
processing the uncategorized merchant financial document data associated with the uncategorized merchant to identify and extract financial document feature data representing one or more financial document features included in the uncategorized merchant financial document data; and
providing the financial document feature data to the trained machine learning-based merchant business segment prediction model.

7. The computing system implemented method of claim 1 wherein a business segment is identified by a business segment code associated with a standardized business segment classification system selected from the set of standardized business segment classification systems comprising:
the North American Industry Classification System (NAICS); and
the Merchant Category Code (MCC) system.

8. A computing system implemented method comprising:
obtaining categorized merchant financial documents data representing one or more financial documents associated with one or more categorized merchants, each of the one or more categorized merchants having been identified as conducting business in a respective business segment;
processing the categorized merchant financial documents data and generating categorized merchant financial document training data by correlating features of the categorized merchant financial documents data for each of the categorized merchants with the respective business segment associated with each of the categorized merchants;
using the categorized merchant financial document training data to train a machine learning-based merchant business segment prediction model to determine business segment probability scores based on merchant financial document data;
obtaining subject merchant financial document data representing financial documents associated with a subject merchant, the subject merchant having been previously identified as conducting business in a respective business segment;
providing the subject merchant financial document data to the trained machine learning-based merchant business segment prediction model;
determining, using the machine learning-based merchant business segment prediction model, a probable business segment for the subject merchant;
comparing the determined probable business segment for the subject merchant to the previously identified business segment for the subject merchant; and
if the determined probable business segment for the subject merchant and the previously identified business segment for the subject merchant differ by a threshold amount, labeling the subject merchant for further investigation, subjecting the subject merchant to further investigation.

9. The computing system implemented method of claim 8 wherein the one or more financial documents include one or more financial documents selected from the set of financial documents comprising:
invoices generated by the merchants;
invoices received by the merchants;
estimates provided by the merchants;
inventory documents associated with the merchants;
revenue documents associated with the merchants;
accounting documents associated with the merchants;
correspondence documents associated with the merchants;
social media postings associated with the merchants;
website postings associated with the merchants;
domain names associated with the merchants;
email addresses associated with the merchants;
phone numbers associated with the merchants; and
addresses associated with the merchants.

10. The computing system implemented method of claim 8 wherein processing the categorized merchant financial documents data to generate categorized merchant financial document training data includes:
processing the categorized financial document data for each categorized merchant to identify and extract financial document feature data representing one or more financial document features and labeling the financial document feature data with the respective business segment data representing the business segment associated with that categorized merchant; and
using the extracted financial document feature data and business segment data to train the machine learning-based merchant business segment prediction model to generate a probable business segment score for uncategorized merchant indicating a probability that the uncategorized merchant is conducting business in one or more specific business categories.

11. The computing system implemented method of claim 10 wherein providing the subject merchant financial document data to the trained machine learning-based merchant business segment prediction model further comprises:
processing the subject merchant financial document data associated with the subject merchant to identify and extract financial document feature data representing one or more financial document features included in the subject merchant financial document data; and
providing the financial document feature data to the trained machine learning-based merchant business segment prediction model.

12. The computing system implemented method of claim 8 wherein a business segment is identified by a business segment code associated with a standardized business segment classification system selected from the set of standardized business segment classification systems comprising:
the North American Industry Classification System (NAICS); and
the Merchant Category Code (MCC) system.

13. The computing system implemented method of claim 8 wherein if the subject merchant is labeled for further investigation, based on the further investigation one or more actions are taken.

14. The computing system implemented method of claim 13 wherein the one or more actions taken include one or more of:
contacting the subject merchant to clarify the discrepancy in business segment assignment;
assigning the newly determined business segment to the subject merchant;
suspending all subject merchant activity within a data management system used by the subject merchant until the discrepancy in business segment assignment is resolved;
sending financial document data associated with the subject merchant to a fraud/criminal activity specialist for analysis; and
closing down any accounts within a data management system used by the subject merchant.

15. A computing system implemented method comprising:
obtaining categorized merchant financial documents data representing one or more financial documents associated with one or more categorized merchants, each of the one or more categorized merchants having been identified as conducting business in a respective business segment;
processing the categorized merchant financial documents data and generating categorized merchant financial document training data by correlating features of the categorized merchant financial documents data for each of the categorized merchants with the respective business segment associated with each of the categorized merchants;
using the categorized merchant financial document training data to train a machine learning-based merchant business segment prediction model to determine business segment probability scores based on merchant financial document data;
providing the machine learning-based merchant business segment prediction model for using in determining business segment probability scores based on merchant financial document data.

16. The computing system implemented method of claim 15 wherein the one or more financial documents include one or more financial documents selected from the set of financial documents comprising:
invoices generated by the merchants;
invoices received by the merchants;
estimates provided by the merchants;
inventory documents associated with the merchants;
revenue documents associated with the merchants;
accounting documents associated with the merchants;
correspondence documents associated with the merchants;
social media postings associated with the merchants;
website postings associated with the merchants;
domain names associated with the merchants;
email addresses associated with the merchants;
phone numbers associated with the merchants; and
addresses associated with the merchants.

17. The computing system implemented method of claim 15 wherein processing the categorized merchant financial documents data to generate categorized merchant financial document training data includes:
processing the categorized financial document data for each categorized merchant to identify and extract financial document feature data representing one or more financial document features and labeling the financial document feature data with the respective business segment data representing the business segment associated with that categorized merchant; and
using the extracted financial document feature data and business segment data to train the machine learning-based merchant business segment prediction model to generate a probable business segment score for uncategorized merchant indicating a probability that the uncategorized merchant is conducting business in one or more specific business categories.

18. The computing system implemented method of claim 15 wherein the machine learning-based merchant business segment prediction model is a supervised machine learning-based merchant business segment prediction model.

19. The computing system implemented method of claim 15 wherein the machine learning-based merchant business segment prediction model is an unsupervised machine learning-based merchant business segment prediction model.

20. The computing system implemented method of claim 15 wherein a business segment is identified by a business segment code associated with a standardized business segment classification system selected from the set of standardized business segment classification systems comprising:
the North American Industry Classification System (NAICS); and
the Merchant Category Code (MCC) system.
